(19) United States
(12) Patent Application Publication
(10) Pub. No.: US 2025/0083734 A1
(43) Pub. Date: Mar. 13, 2025

(54) STEERING DEVICE FOR MOTOR VEHICLE, STEER-BY-WIRE STEERING SYSTEM AND MOTOR VEHICLE

(71) Applicants: Hangzhou Kingway Technology Co., Ltd., Zhejiang (CN); NSK EUROPE LIMITED, Maidenhead Berkshire (GB)

(72) Inventors: Christian Michael STRAUB, Frankfurt am Main (DE); Edwin BREUNING, Denkendorf (DE)

(73) Assignees: Hangzhou Kingway Technology Co., Ltd., Zhejiang (CN); NSK EUROPE LIMITED, Maidenhead Berkshire (GB)

(21) Appl. No.: 18/961,484

(22) Filed: Nov. 27, 2024

Related U.S. Application Data
(63) Continuation of application No. PCT/EP2022/065850, filed on Jun. 10, 2022.

(51) Int. Cl. B62D 5/00; B62D 5/04; B62D 15/02

(52) U.S. Cl. CPC B62D 5/006; B62D 5/0403; B62D 15/02

(57) ABSTRACT

A steering device for a motor vehicle, in particular for use in a steer-by-wire steering system, comprises a steering handle rotatable about an axis of the steering device, and a restoring torque generating arrangement coupled to the steering handle and configured to generate a torque that at least partially counteracts rotation of the steering handle. The restoring torque generating arrangement comprises a motor having a hollow core coaxial to the axis of the steering device, and a gear coupled to the motor and configured to transmit a torque produced by the motor to the steering handle. The gear has a hollow central region coaxial to the axis of the steering device and a gear ratio within the range from 20:1 to 100:1.

### CROSS-REFERENCE TO RELATED APPLICATION

The present application is a continuation of International Application No. PCT/EP2022/065850, filed on Jun. 10, 2022. The disclosure of the aforementioned-application is incorporated herein by reference in its entirety.

### BACKGROUND

### Technical Field

The application relates to a steering device for a motor vehicle. The application further relates to a steer-by-wire steering system and a motor vehicle.

### Description of Related Art

In conventional steering systems, for example, in motor vehicles, a desired steering angle that is input by a driver is transmitted mechanically to a steerable wheel suspension via a steering gear. In the case of a steer-by-wire steering system, by contrast, a driver's input via the steering handle is detected and transmitted by electrical means to actuators for steering the vehicle wheels. Detecting a driver's steering input is typically performed with the aid of one or more sensors, and the sensor signals are processed by means of a control unit, which then generates a corresponding control signal for operating the steering actuator(s).

In a steer-by-wire steering system the wheels of a motor vehicle are mechanically decoupled from the steering handle. As a consequence, forces that act on the wheels during a steering manoeuver are not transmitted to the steering handle. In order to provide the driver with a driving sensation similar to a conventional steering system, it is known to include a restoring torque generating arrangement in the steering system. A restoring torque generating arrangement typically includes an electric motor which can be controlled to exert a torque on the steering handle, which can be adapted in strength and direction to a current driving and/or steering condition.

Providing a restoring torque generating arrangement in a steering device contravenes the general desire for a compact arrangement of a steering device in a vehicle. This problem is enhanced by the requirement of a gear which typically needs to be arranged between the motor of the restoring torque generating arrangement and the steering handle.

Furthermore, including a restoring torque generating arrangement in a steering device often hinders a suitable integration of electrical, optical or other sorts of supply lines, such as electrical and/or optical wiring, for interface functionalities which are arranged at the steering handle.

Furthermore, a restoring torque which is applied to the steering handle by the restoring torque generating arrangement is typically acted against, and surmounted, by the driver when he or she turns the steering handle. On many occasions, this leads to a high load state of the electric motor while the motor is not moving or is moving less and/or differently than would correspond to the applied current. This often causes undesired heating of the motor.

However, even at low currents heating of the motor may occur. For example, while driving on straight roads vehicle drivers tend to make minor, including subconscious, steering motions, or tend to slowly drift towards one of either sides, alternatingly. In such a case the restoring torque generating arrangement may be activated by minor displacements of the steering handle while essentially no steering motion takes place. As an effect, an operating current of the electric motor of the restoring torque generating arrangement remains applied to a same electric phase of the motor over a longer period. This can result in excessive heating of individual parts of the motor.

Therefore, a technique is desirable that avoids, or at least mitigates, at least one the aforesaid disadvantages.

### SUMMARY

Accordingly, there is provided a steering device according to claim 1, a steer-by-wire steering system according to claim 17 and a vehicle according to claim 18.

According to a first aspect, a steering device for a motor vehicle, in particular for use in a steer-by-wire steering system, is provided. The steering device comprises a steering handle rotatable about an axis of the steering device, and a restoring torque generating arrangement coupled to the steering handle and configured to generate a torque that at least partially counteracts rotation of the steering handle. The restoring torque generating arrangement comprises a motor having a hollow core coaxial to the axis of the steering device, and a gear coupled to the motor and configured to transmit a torque produced by the motor to the steering handle. The gear has a hollow central region coaxial to the axis of the steering device and a gear ratio within the range from 20:1 to 100:1.

Thus, a compact implementation of the restoring torque generating arrangement in the steering device is facilitated. Moreover, an integration of at least one electrical, optical and/or other sort of supply line for one or more interface functionalities arranged at the steering handle and/or steering system is improved. In addition, heating-up of the motor of the restoring torque generating arrangement can be avoided or reduced.

The gear ratio can be in the range from 20:1 to 75:1, from 20:1 to 50:1, from 22:1 to 38:1, in the range from 25:1 to 35:1, or in the range from 28:1 to 32:1.

The gear ratio is chosen such that minor displacements of the steering handle, in particular displacements which cause activation of the restoring torque generating arrangement, correspond to a switching between different electrical phases of the motor. In addition, the gear ratio is chosen such that typical steering manoeuvers do not correspond to an excessively high number of revolutions of the motor at which undesired noise of the motor likely occurs. The steering device can further comprise an at least partially hollow steering column which extends through the hollow core of the motor and the hollow central region of the gear.

The motor can comprise a stator and a rotor. The stator can be an inner stator and the rotor can be an outer rotor.

In some configurations, the motor can further be configured to rotate the steering handle at least partially in accordance with a current driving situation. More precisely, in particular in semi-autonomous and/or fully autonomous vehicles, the motor can be configured to rotate the steering handle at least partially in accordance with turning of the vehicle. More precisely, the motor can cause the steering handle to rotate during transfer operations in which the operation changes from an autonomous or semi-autonomous driving state to a manual driving state or vice versa, i.e. during a transfer situation in which the driver hands over the steering to the system or vice versa.

The gear can be arranged to at least partially overlap the motor in a radial direction relative to the axis of the steering device. In addition or as an alternative, the gear can be arranged to at least partially overlap the motor in an axial direction along the axis of the steering device.

The gear can comprise a strain wave gear or harmonic gearing. In addition or as an alternative, the gear can comprise a planetary gear.

The gear can comprise an inner gear member configured to be driven by means of the motor, at least one intermediate gear member and an outer gear member. The at least one intermediate gear member can be engaging with an outer surface of the inner gear member and with an inner surface of the outer gear member.

The rotor can be formed integrally with the inner gear member of the gear. Thus, an extension of the gear over an extension of the motor in an axial direction towards the steering handle can be reduced or avoided.

The outer gear member can be arranged rotationally fixed with respect to the steering handle. In that case, the intermediate gear member can be arranged rotationally and axially fixed with respect to the at least partially hollow steering column and/or the stator.

As an alternative, the intermediate gear member can be arranged rotationally fixed with respect to the steering handle. In that case, the outer gear member can be arranged rotationally and axially fixed with respect to the at least partially hollow steering column and/or the stator.

The intermediate gear member and/or the inner gear member can be arranged to at least partially enclose the motor in a radial direction. In addition or as an alternative, the intermediate gear member and/or the inner gear member can be arranged to at least partially enclose the motor in an axial direction.

In embodiments of the steering device in which the gear comprises a strain wave gear, the intermediate gear member can comprise a flexspline of the strain wave gear. Further, the inner gear member can comprise a wave generator of the strain wave gear which is rotatably arranged within the flexspline, and the outer gear member can comprise a circular spline of the strain wave gear.

In embodiments of the steering device in which the gear comprises a planetary gear, the inner gear member can comprise a sun gear of the planetary gear. Further, the intermediate gear member can comprise an arrangement of one or more planet gears rotatably attached to a carrier, and the outer gear member can comprise a ring gear of the planetary gear.

The restoring torque generating arrangement can further comprise at least one cooling device configured to provide cooling of the motor when the motor is moving.

The steering device can further comprise at least one electrical and/or optical interface functionality arranged at the steering handle and/or within the steering system. An electrical wiring, an optical wiring and/or an optical path of the at least one electrical and/or optical interface functionality can extend at least partially within the hollow core of the motor and/or within the hollow central region of the gear.

The at least one electrical and/or optical interface functionality can comprise at least one of a heating of the steering handle, a display, a lighting, an airbag, or a control.

The steering device can further comprise at least one sensor device. The at least one sensor device can be configured to detect a steering input provided by a user via the steering handle and to generate a sensor signal indicative of the detected steering input.

According to another aspect, a steer-by-wire steering system, in particular for use in a motor vehicle, is provided. The steer-by-wire steering system comprises a steering device as presently provided.

According to another aspect, a motor vehicle is provided. The motor vehicle comprises a steer-by-wire steering system as presently provided.

### BRIEF DESCRIPTION OF THE DRAWINGS

Further details, advantages and objectives of the application become apparent from the drawings and the detailed description. In the drawings, there is shown:

FIGS. 1A, 1B, 2A and 2B: steering devices for a motor vehicle according to various examples;

FIG. 3: a steer-by-wire steering system, in particular for use in a motor vehicle, according to an example; and

FIG. 4: a motor vehicle comprising a steer-by-wire steering system, according to an example.

### DESCRIPTION OF THE EMBODIMENTS

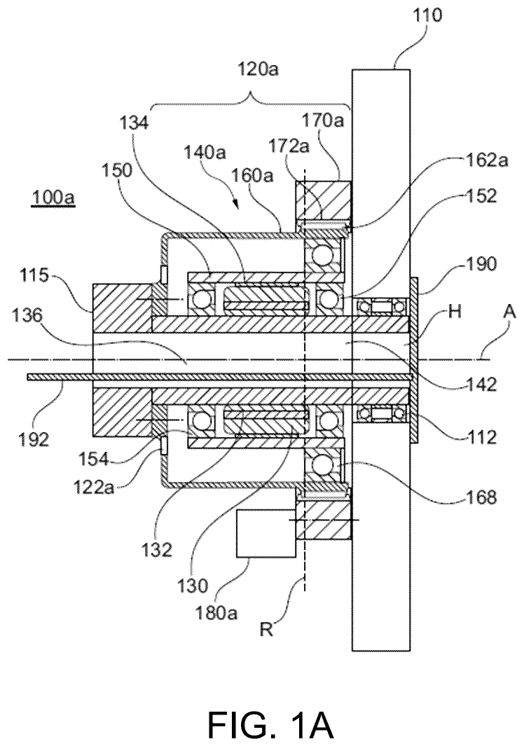

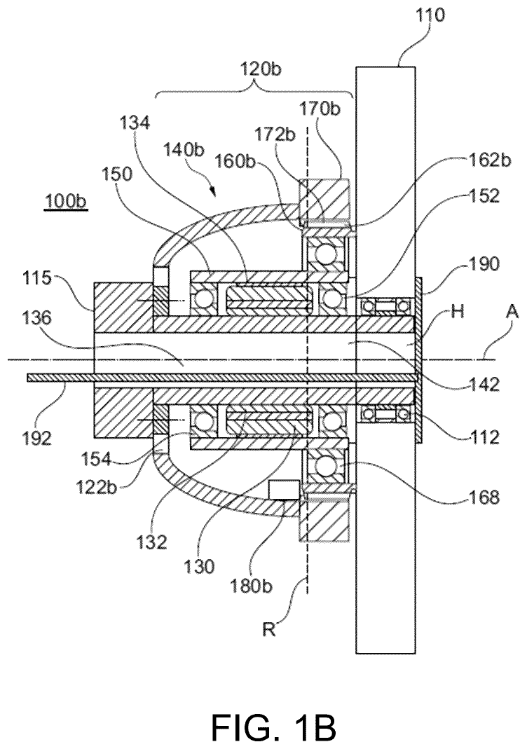

FIG. 1A shows schematically and exemplarily a steering device 100a, in particular for use in a motor vehicle. The steering device 100a comprises a steering handle 110, which is mounted rotatably about an axis A. By rotating the steering handle 110 about the axis A, a user provides a steering input to the steering device 100a. In the shown example, the steering handle 110 is supported by a steering column 115 of the steering device 100a and is rotatably attached to the steering column 115 via steering handle bearing 112. The steering column 115 can be configured to become rigidly mounted relative to a chassis of a motor vehicle in which the steering device 100a is to be used, for example, as a part of a steer-by-wire steering system.

The steering device 100a further comprises a restoring torque generating arrangement 120a. The restoring torque generating arrangement 120a is arranged to exert a restoring torque on the steering handle 110 which at least partially counteracts a rotation of the steering handle 110, when a steering input is provided by a user via the steering handle 110. The restoring torque generating arrangement 120a comprises a motor 130 and a gear 140a. A stator 132 of the motor 130 is rotationally fixed with respect to the steering column 115, and a rotor 134 of the motor 130 is rotationally fixed with respect to the steering handle 110 via the gear 140a. Accordingly, a torque generated by the motor 130 is transmitted via the gear 140a to the steering handle 110, resulting in a torque between the steering handle 110 and the steering column 115.

The motor 130 has a hollow core 136. Furthermore, the gear 140a has a hollow central region 142. The restoring torque generating arrangement 120a thus enables that a hollow conduit H is provided which extends through the hollow core 136 of the motor 130 and the hollow central region 142 of the gear 140a. In the shown example, the hollow conduit H extends through the steering column 115 coaxially with the axis A of the steering device 100a.

The hollow conduit H facilitates the provision of one or more electrical and/or optical interface functionalities 190, which are arranged at the steering handle 110, as an electrical or optical wiring and/or an optical path 192, as well as any other sort of supply line, of the electrical and/or optical interface functionality 190 can be accommodated in the hollow conduit H.

The hollow conduit H thus facilitates a compact and robust arrangement of an electrical, optical or any other sort of supply line for interface functionalities which may be arranged at the steering handle 110.

The at least one electrical and/or optical interface functionality 190 comprises, for example, a heating of the steering handle 110, a display for outputting graphical information to the user, a lighting, such as a decorative illumination, an illuminated logo, or a lighting of control functions arranged at the steering handle 110, an airbag which is accommodated in some examples of the steering handle 110, or any sort of control, such as one or more control buttons, control wheels, touch-sensitive control elements, etc. Apart from electrical or optical wiring, which may be accommodated in the hollow conduit H, the hollow conduit H may also be part of an optical path for light propagating inside the hollow conduit H, for example, as part of an optical projection towards the steering handle 110.

The steering device 100a further comprises a sensor device 180a. The sensor device 180a is configured to detect a steering input provided by a user via the steering handle 110 and to generate a sensor signal indicative of the detected steering input. The sensor device 180a is adapted to detect one or more physical characteristics which are indicative of a steering input provided via the steering handle 110, such as a steering angle or a motion of the steering handle 110 relative to the steering column 115 or a chassis of the motor vehicle in which the steering device 100a is to be installed, etc, and to generate a sensor signal that corresponds to the detected one or more physical characteristics. The sensor signal is output by the sensor device 180a towards a control unit, for example, a control unit of a steer-by-wire steering system of the motor vehicle. Based on the sensor signal, the control unit generates in some examples a control signal for output to the motor 130 so as to counteract at least partially the detected steering input. For example, a control signal for the motor 130 is generated such that a voltage applied to the motor 130 increases in accordance with an increased steering angle which is input via the steering handle 110.

In some examples, the sensor signal is also configured to be used by a control unit for determining a corresponding control signal for output towards one or more steering actuators of the steering system.

The gear 140a is a strain wave gear. It comprises an inner gear member in the form of a wave generator 150. The wave generator 150 is arranged rotatably with respect to the steering column 115, which it is attached to via a first wave generator bearing 152 and a second wave generator bearing 154. The wave generator 150 is driven by the motor 130. For this purpose, the wave generator 150 is connected to the rotor 134 of the motor 130. At an outside of the wave generator 150, the wave generator 150 engages with an inner surface of an intermediate member of the gear 140a in the form of a flexspline 160a via a flexspline bearing 168.

The flexspline 160a is flexible with respect to a cross section. Moreover, in the shown example, the flexspline 160a is rotationally fixed with respect to the steering column 115. The wave generator 150 has a cam-shaped outer periphery, normally resembling an ellipse. Rotation of the wave generator 150 by operating the motor 130 will thus result in an elliptic deformation of a cross section of the flexspline 160a, which propagates in a rotating manner along a circumference of the flexspline 160a.

The gear 140a further comprises an outer gear member in the form of a circular spline 170a. In the shown example, the circular spline 170a is rotationally fixed with respect to the steering handle 110. Furthermore, a toothed outer profile 162a at an outside of the flexspline 160a engages with a toothed inner profile 172a of the circular spline 170a. The cam shape of the wave generator is dimensioned such that the toothed outer profile 162a and the toothed inner profile 172a engage near the apex area of each cam, whereas the toothed outer profile 162a and the toothed inner profile 172a disengage in areas remote from an apex area of each cam as an effect of the deformation of the cross section of the flexspline 160a. A difference between the numbers of teeth contained in the toothed outer profile 162a and the toothed inner profile 172a causes a relative rotation between the flexspline 160a and the circular spline 170a when the wave generator 150 is moving. As in the shown example the flexspline 160a is rotationally fixed, the relative rotation between the flexspline 160a and the circular spline 170a results in a rotation of the handwheel 110 relative to the steering column 115.

The gear 140a is configured to have a gear ratio in the range from 20:1 to 100:1. In some examples, the gear 140a has a gear ratio in the range from 22:1 to 38:1, in the range from 25:1 to 35:1, or in the range from 28:1 to 32:1.

A gear ratio within the aforementioned range has been found to be advantageous with respect to avoiding overheating of the motor 130 as a result of continuous application of electric current on a same electric phase of the motor 130, for example, in the presence of minor input angles, as they typically occur during long driving on straight roads. A gear ratio within the aforementioned range ensures that an electric phase switching occurs even in the presence of only minor, typical, input angles. That is, the gear ratio is sufficiently large for providing that even a small variation of the input angle at the steering handle 110 corresponds in typical situations to an angle of the rotor 134 of the motor 130 that extends over at least one phase switching.

In addition, a gear ratio within the aforementioned range has been found to be advantageous with respect to avoiding undesired noise of the motor 130 as a result of high numbers of revolution of the motor 130, for example, in typical steering manoeuvers. Noise generation usually results if an input angle at the steering handle 110 in typical steering manoeuvers corresponds, according to the gear ratio, to an angle of the rotor 134 of the motor 130 that extends over an excessively large number of revolutions. That is, a gear ratio within the aforementioned range has been found advantageously small to avoid excessively high revolution numbers of the motor 130 in typical driving situations.

The gear 140a is further arranged such that it partially overlaps and encloses the motor 130 in a radial direction R. In this manner a compact arrangement of the steering device 100 is facilitated. In the shown example, the gear 140a also overlaps and encloses the motor 130 in an axial direction, that is, in a direction parallel to the axis A. In particular, the motor 130 is enclosed by the wave generator 150 and its bearings 152, 154.

In other examples, the motor 130 is not enclosed by the gear 140a in an axial direction. In some examples, the wave generator 150 is formed integrally with the rotor 134 of the motor 130. Additional wave generator bearings 152, 154 can be dispensed with in such a case. Moreover, the gear 140a does not extend beyond the motor 130 in a direction towards the steering handle 110 in some examples. A compact arrangement of the restoring torque generating arrangement 120a is further facilitated in this way.

The steering device 100a further includes at least one cooling device 122a. The cooling device 122a provides for cooling of the motor 130, especially when the motor 130 is moving. A simple implementation of the cooling device 122a comprises a ventilation hole, or a ventilation grid, which is arranged in the flexspline 160a and which permits exhaustion of warm air from an inside of the flexspline 160a and its replacement by cooler air from outside. In other examples, the cooling device 122a further comprises a fan which is driven by the motor 130 and which increases an exchange of air between an inside and an outside of the flexspline 160a and/or between an inside and an outside of the wave generator 150. Other examples of the cooling device 122a contain additional or other means for transporting heat from the motor 130 towards an outside of the steering device 100a.

In the example shown in FIG. 1A, the circular spline 170a is rotationally fixed with respect to the steering handle 110, and the flexspline 160a is rotationally fixed with respect to the steering column 115 and the stator 132. In other examples, as shown in FIG. 1B, a steering device 100b comprises a restoring torque generating arrangement 120b with a gear 140b, in which the flexspline 160b is rotationally fixed with respect to the steering handle 110, and the circular spline 170b is rotationally fixed with respect to the steering column 115 and the stator 132. A direction of the resultant motion of the steering handle 110 relative to a direction of the motor 130 in the steering device 100b is inverse to the direction of the resultant motion of the steering handle 110 relative to the direction of the motor 130 in the steering device 100a. An operation of the motor 130 therefore is adapted accordingly. In addition, when dimensioning either of the gears 140a, 140b, it is to be considered that an effective gear ratio of a strain wave gear varies depending on whether the gear output occurs via the circular spline or the flexspline, in that in the latter case the nominal gear ratio, that is, n:1, applies, whereas in the former case the effective gear ratio is increased by 1 relative to the nominal ratio, that is, (n+1):1.

The steering device 100b further comprises a toothed outer profile 162b of the flexspline 160b, a toothed inner profile 172b of the circular spline 170b, a cooling device 122b, and a sensor device 180b. Subject to the aforementioned differences between the gears 140a and 140b, these features correspond functionally and structurally to the respective elements 162a, 172a, 122a, 180a of the steering device 100a, as will be understood from FIGS. 1A and 1B. Notably, in the example shown in FIG. 1B, the sensor device 180b is arranged to detect a relative motion between the flexspline 160b and the steering column 115.

In the examples shown in FIGS. 1A and 1B, each of the steering devices 100a, 100b comprise a steering column 115 extending through the hollow core 136 and the hollow central region 142 of the gear 140a, 140b. In other examples, a steering device 100a, 100b does not comprise a steering column 115. Instead, in some examples, the stator 132 is attached to a base plate, and the gear 140a, 140b and the steering handle 110 are flanged to each other and connected to the rotor 134 without additional support by a steering column.

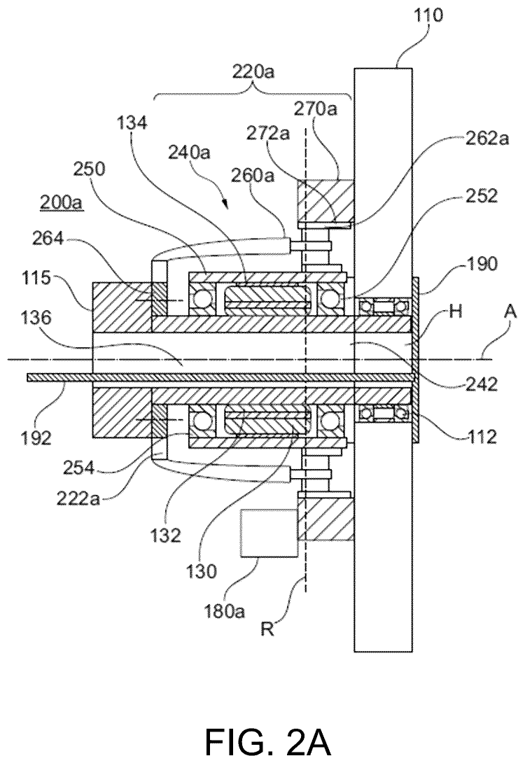

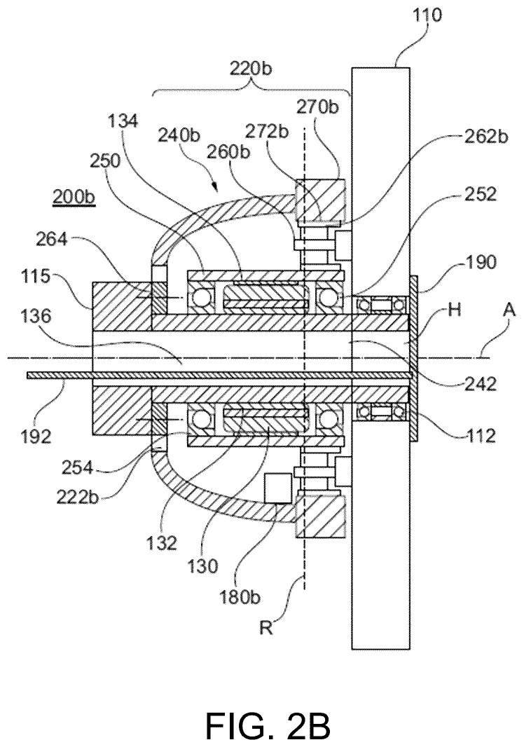

FIG. 2A shows schematically and exemplarily a steering device 200a, in particular for use in a motor vehicle, according to another example. Unless stated otherwise or implicitly clear from the following, the above description of the steering device 100a shown in FIG. 1A applies correspondingly to the steering device 200a shown in FIG. 2A. Identical reference signs as in FIG. 1A denote identical or similar features that serve an identical purpose.

The steering device 200a comprises a restoring torque generating arrangement 220a, including an electric motor 130 and a gear 240a. The gear 240a comprises a planetary gear. In the arrangement shown, a sun gear 250 forms an inner gear member of the gear 240a which is driven by the motor 130. An arrangement 260a of one or more planet gears rotatably attached to a carrier and each having a toothed profile 262a constitutes an intermediate gear member. A ring gear 270a having a toothed inner profile 272a constitutes an outer gear member of the planetary gear 240a.

The description of the strain wave gear 140a in FIG. 1A applies correspondingly to the planet gear 240a in FIG. 2A, as applicable. In particular, in the steering device 200a, the ring gear 270a is rotationally fixed with respect to the steering handle 110, and the arrangement 260a of one or more planet gears rotatably attached to a carrier is rotationally fixed with respect to the steering column 115 and the stator 132. Furthermore, the steering device 200a comprises a cooling device 222a. The cooling device 222a corresponds essentially to the cooling device 122a of the steering device 100a, subject to structural adaptations to the gear 240a.

In other examples, as shown in FIG. 2B, a steering device 200b comprises a restoring torque generating arrangement 220b with a gear 240b, in which the arrangement 260b of one or more planet gears rotatably attached to a carrier is rotationally fixed with respect to the steering handle 110, and the ring gear 270b is rotationally fixed with respect to the steering column 115 and the stator 132.

The steering device 200b further comprises a toothed profile 162b at each of the planet gears, a toothed inner profile 272b of the ring gear 270b, a cooling device 222b, and a sensor device 180b. Subject to the aforementioned differences between the gears 240a and 240b, these features correspond functionally and structurally to the respective elements 262a, 272a, 222a, 180a of the steering device 200a, as will be understood from FIGS. 2A and 2B. Notably, in the example shown in FIG. 2B, the sensor device 180b is arranged to detect a relative motion between the arrangement 260b of one or more planet gears rotatably attached to a carrier and the steering column 115.

In some examples of the steering devices 200a, 200b the sun gear 250 is arranged separate from the rotor 134 of the motor 130. In other examples of the steering devices 200a, 200b the sun gear 250 is formed integrally with the rotor 134 of the motor 130.

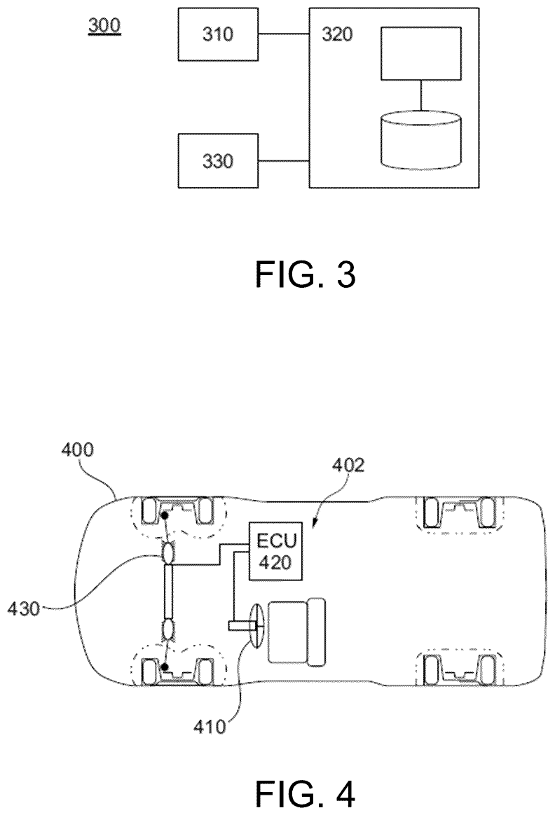

FIG. 3 shows schematically and exemplarily a steer-by-wire steering system 300, in particular for use in a motor vehicle. The steer-by-wire steering system 300 comprises a steering device 310. The steering device 310 is a steering device as described in connection with the steering devices 100a, 100b, 200a, 200b shown in FIGS. 1A to 2B.

The steer-by-wire steering system 300 further comprises a control unit 320. The control unit 320 is operably connected to the steering device 310. The control unit 320 comprises a processing unit and is configured to receive a sensor signal from a sensor device of the steering device 310. The sensor signal indicates a steering input which is provided by a user at the steering device 310. The control unit 320 is further configured to generate, by means of the processing unit and at least partially based on the received sensor signal, a control signal for operating a motor of a restoring torque generating arrangement of the steering device 310 and to output the generated control signal towards the motor of the steering device 310. In some examples, the control unit 320 is further configured to generate the control signal for the restoring torque generating arrangement based on additional information, such as a present velocity of the motor vehicle, a present inclination of the motor vehicle, a present terrain, a wheel spin, etc.

Furthermore, the control unit 320 is configured to generate, by means of the processing unit and at least partially based on the received sensor signal, a control signal for operating one or more steering actuators 330 of the motor vehicle. The control unit 320 is further configured to output the generated control signal towards the one or more steering actuators 330.

FIG. 4 shows schematically and exemplarily a motor vehicle 400. The motor vehicle 400 comprises a steer-by-wire steering system 402 as described in connection with the steer-by-wire steering system 300 shown in FIG. 3. In particular, the steer-by-wire steering system 402 comprises a steering device 410, a control unit 420, and one or more steering actuators 430. The steering device 410 is a steering device as described in connection with the steering devices 100a, 100b, 200a, 200b shown in FIGS. 1A to 2B. The control unit 420 is a control unit as described in connection with control unit 320 of the steer-by-wire steering system 300 shown in FIG. 3.

What is claimed is:

1. A steering device for a motor vehicle, for use in a steer-by-wire steering system, the steering device comprising:
a steering handle rotatable about an axis of the steering device, and
a restoring torque generating arrangement coupled to the steering handle and configured to generate a torque that at least partially counteracts rotation of the steering handle, the restoring torque generating arrangement comprising:
a motor having a hollow core coaxial to the axis of the steering device, and
a gear coupled to the motor and configured to transmit a torque produced by the motor to the steering handle,
wherein
the gear has a hollow central region coaxial to the axis of the steering device and a gear ratio within the range from 20:1 to 100:1.

2. The steering device according to claim 1, wherein the gear ratio is in the range from 22:1 to 38:1, in the range from 25:1 to 35:1, or in the range from 28:1 to 32:1.

3. The steering device according to claim 1, further comprising an at least partially hollow steering column which extends through the hollow core of the motor and the hollow central region of the gear.

4. The steering device according to claim 2, further comprising an at least partially hollow steering column which extends through the hollow core of the motor and the hollow central region of the gear.

5. The steering device according to claim 3, wherein the motor comprises a stator and a rotor, wherein, the stator is an inner stator and the rotor is an outer rotor.

6. The steering device according to claim 5, wherein the gear is arranged to at least partially overlap the motor in a radial direction relative to the axis of the steering device and/or to at least partially overlap the motor in an axial direction along the axis of the steering device.

7. The steering device according to claim 5, wherein the gear comprises a strain wave gear and/or a planetary gear.

8. The steering device according to claim 7, wherein the gear comprises an inner gear member configured to be driven by means of the motor, at least one intermediate gear member and an outer gear member, the at least one intermediate gear member engaging with an outer surface of the inner gear member and with an inner surface of the outer gear member.

9. The steering device according to claim 8, wherein the outer gear member is arranged rotationally fixed with respect to the steering handle, and the intermediate gear member is arranged rotationally and axially fixed with respect to the at least partially hollow steering column and/or the stator, respectively.

10. The steering device according to claim 8, wherein the intermediate gear member is arranged rotationally fixed with respect to the steering handle, and the outer gear member is arranged rotationally and axially fixed with respect to the at least partially hollow steering column and/or the stator, respectively.

11. The steering device according to claim 8, wherein the intermediate gear member and/or the inner gear member are arranged to at least partially enclose the motor in a radial direction and/or an axial direction.

12. The steering device according to claim 8, wherein the gear comprises a strain wave gear and wherein the intermediate gear member comprises a flexspline, the inner gear member comprises a wave generator rotatably arranged within the flexspline, and the outer gear member comprises a circular spline of the strain wave gear.

13. The steering device according to claim 8, wherein the gear comprises a planetary gear and wherein the inner gear member comprises a sun gear, the intermediate gear member comprises an arrangement of one or more planet gears rotatably attached to a carrier, and the outer gear member comprises a ring gear of the planetary gear.

14. The steering device according to claim 1, wherein the restoring torque generating arrangement further comprises at least one cooling device configured to provide cooling of the motor when the motor is moving, and/or
further comprising at least one sensor device configured to detect a steering input provided by a user via the steering handle and to generate a sensor signal indicative of the detected steering input.

15. The steering device according to claim 2, wherein the restoring torque generating arrangement further comprises at least one cooling device configured to provide cooling of the motor when the motor is moving, and/or
further comprising at least one sensor device configured to detect a steering input provided by a user via the steering handle and to generate a sensor signal indicative of the detected steering input.

16. The steering device according to claim 3, wherein the restoring torque generating arrangement further comprises at least one cooling device configured to provide cooling of the motor when the motor is moving, and/or
further comprising at least one sensor device configured to detect a steering input provided by a user via the steering handle and to generate a sensor signal indicative of the detected steering input.

17. The steering device according to claim 4, wherein the restoring torque generating arrangement further comprises at least one cooling device configured to provide cooling of the motor when the motor is moving, and/or
further comprising at least one sensor device configured to detect a steering input provided by a user via the steering handle and to generate a sensor signal indicative of the detected steering input.

18. The steering device according to claim 1, further comprising at least one electrical and/or optical interface functionality arranged at the steering handle, wherein an electrical wiring, an optical wiring and/or an optical path of the at least one electrical and/or optical interface functionality extends at least partially within the hollow core of the motor and/or within the hollow central region of the gear, wherein, the at least one electrical and/or optical interface functionality comprises at least one of a heating of the steering handle, a display, a lighting, an airbag, or a control.

19. A steer-by-wire steering system, for use in a motor vehicle, comprising a steering device according to claim 1.

20. A motor vehicle comprising a steer-by-wire steering system according to claim 19.
